(19) United States
(12) Patent Application Publication
(10) Pub. No.: US 2026/0338137 A1
(43) Pub. Date: Oct. 29, 2026

(54) Hybrid Autophage Rocket Motor

(71) Applicant: Alpha Impulsion, Toulouse (FR)

(72) Inventor: Marius Celette, Lyon (FR)

(21) Appl. No.: 19/107,934

(22) PCT Filed: Sep. 4, 2023
(86) PCT No.: PCT/FR2023/051333

§ 371 Date: Feb. 28, 2025

(30) Foreign Application Priority Data
Sep. 2, 2022 (FR) FR2208425

(51) Int. Cl. F02K 9/72; B64G 1/00; B64G 1/40; F02K 9/10; F02K 9/24

(52) U.S. Cl. CPC F02K 9/72; B64G 1/002; B64G 1/4021; B64G 1/404; F02K 9/10; F02K 9/24

(57) ABSTRACT

The present invention relates to a jet propulsion system provided with a hybrid rocket engine and, more specifically, to the storage of the fuels before they are introduced into the combustion chamber. This propulsion system is made up of a combustion chamber (1) closed by a cap (2) and a valve (3). A solid propellant (4) is used as a tank for a liquid propellant (5). These two propellants are introduced into the chamber (1) in order to be burned therein. The gases produced by this combustion are discharged via a nozzle (6) in order to provide a propulsive thrust. The system is a self-eating system in that it burns its own structure in order to launch. The propulsion system described by the present invention is particularly intended for propelling space vehicles and launchers.

### TECHNICAL FIELD

The present invention relates to a jet propulsion system, particularly for a space launch vehicle, which is provided with a hybrid rocket motor and, more specifically, to the storage of the propellants before being inserted in a combustion chamber. Jet chemical rocket motors expel via a nozzle the fluids resulting from a reaction between several propellants in order to generate a thrust which allows travel of the propulsion system and its payload. In the case of hybrid rocket motors, at least one propellant is solid and at least one propellant is fluid.

### PRIOR ART

In the current prior art, the storage of the propellants for rocket motors depends on the type of propellant. Solid propellants are stored directly in the combustion chamber and fluid propellants are stored in tanks with a fixed geometry.

When the propulsion system is in flight, the fluid propellant tanks become emptied and progressively become a deadweight which reduces the performance levels of the overall system. The empty tanks can also be detached from the propulsion system. In this case, they constitute space debris, thereby gradually encumbering space.

### STATEMENT OF INVENTION

The present invention proposes a solution in order to be freed from the constraints connected with the tanks of the propulsion system and to increase the performance levels of the propulsion system. In order to do this, the invention proposes replacing the propulsion systems comprising tanks with a propulsion system provided with autophage storage. More specifically, the present invention comprises a hybrid rocket motor as described in the appended claims.

The following detailed description and the appended drawings will allow a better understanding of the nature and advantages of the present invention.

### BRIEF DESCRIPTION OF THE FIGURES

FIG. 1 schematically describes a hybrid autophage rocket motor according to the present invention,

FIG. 2 illustrates an exemplary embodiment of the invention, in which the hollow solid propellant, in particular the grain of solid propellant, is carried into the combustion chamber by means of a leadscrew system.

### DETAILED DESCRIPTION

The present invention relates to a hybrid rocket motor which is fitted to a jet propulsion system. A hybrid rocket motor is a rocket motor using at least one fluid propellant and at least one solid propellant.

According to the present invention, the hybrid rocket motor comprises a combustion chamber which is fed by a hollow solid propellant and a fluid propellant, the hollow solid propellant having a cavity which is closed by an end-cap and a valve, and the fluid propellant being stored in the cavity of the hollow solid propellant. Furthermore, the hollow solid propellant may comprise a first portion which is inserted in the combustion chamber in order to be burnt there with the fluid propellant which is injected into the combustion chamber through the valve. The combustion will generate hot gases which will be discharged via a nozzle so as to produce a thrust. In particular, the first portion may comprise an internal face towards the combustion space in order to be burnt. The hollow solid propellant may further comprise a second portion which extends out of the combustion chamber and which contains the fluid propellant before both are inserted into the combustion chamber.

Furthermore, another aspect of the present invention relates to a hybrid rocket motor, in which a pressurized combustion chamber which is closed by an end-cap and a valve contains a hollow solid propellant, the internal face of which burns with a fluid propellant which is injected through the end-cap, generating hot gases which are discharged via a nozzle so as to produce a thrust on the vehicle. Some of the hollow solid propellant travels beyond and around the end-cap out of the combustion chamber and contains the fluid propellant before both are inserted into the combustion chamber. In other words, a portion which is delimited by the end-cap of the hollow solid propellant acts as a container for the fluid propellant before both are inserted into the combustion chamber.

Thus, as a result of using a hollow solid propellant as a hollow structure in the form of, for example, any hollow cylinder, which allows the fluid propellant to be stored, the present invention allows a release from the constraints connected with the tanks of the propulsion system and allows the performance levels thereof to be increased.

In particular, the hollow solid propellant is a grain of solid propellant having a hollow structure which is formed from a solid propellant. The hollow solid propellant therefore has a rigid and hollow structure and thus forms a tank, the walls of which are formed by the solid propellant itself.

In particular, the hollow solid propellant comprises a cavity, the cavity containing the fluid propellant and being closed by the end-cap and the valve.

The hollow solid propellant is, for example, formed by a homogeneous structure of solid propellant. The hollow solid propellant may also be formed mostly by solid propellant and may comprise additives or other components (for example, ammonium perchlorate). A solid propellant is particularly not a high-energy propellant, such as, for example, polyethylene or ABS (acrylonitrile butadiene styrene).

The hollow solid propellant is used to contain the fluid propellant which is intended to be burnt in the combustion chamber. In other words, the cavity which is formed in the hollow structure of the hollow solid propellant acts as a container for the fluid propellant.

A fluid propellant may be an oxidant and may be, for example, a liquid cryogenic oxidant.

According to one embodiment, no container or tank or additional structure is necessary to contain the hollow solid propellant. Thus, no rigid enclosure such as a rigid tank is necessary to enclose the hollow solid propellant.

However, a coating may cover the hollow solid propellant in order to increase the rigidity of the hollow solid propellant.

The cavity formed in the hollow solid propellant is closed by the end-cap and the valve, the end-cap being able to comprise the valve.

The cavity comprises, for example, a constant and regular diameter with a, for example, tubular shape and the end-cap has a diameter corresponding to the diameter of the cavity.

According to one embodiment, the end-cap and the valve are not located at the end of the hollow solid propellant, but are instead located inside the hollow solid propellant so as to close the cavity at a given depth. In other words, the end-cap and the valve close the cavity so as to form a first hollow solid propellant portion downstream of the end-cap. The downstream portion of the end-cap is the portion located outside the cavity which is closed by the end-cap. This portion of the hollow solid propellant is inserted into the combustion chamber in order to be burnt there. A second hollow solid propellant portion which is located upstream of the end-cap and the valve acts as a container for the fluid propellant. The second propellant portion particularly extends out of the combustion chamber.

In particular, the end-cap may serve to delimit the hollow solid propellant portion which is intended to contain the fluid propellant of the hollow solid propellant portion which is intended to burn in the combustion chamber.

The cavity formed in the hollow solid propellant is, for example, in the form of any cylinder.

According to the present invention, the hollow solid propellant which forms the tank of the fluid propellant comprises the solid propellant which is used during the combustion for generating the thrust in the combustion chamber.

The hollow solid propellant may be in the form of a straight cylinder with a base, a straight prism or any other simple or complex form, provided with a cavity comprising an opening which is suitable for being closed by an end-cap.

The end-cap may also comprise an injector downstream of the valve in order to introduce the fluid propellant which is contained in the cavity in the combustion chamber.

According to a specific embodiment, the hollow solid propellant may be coated particularly on the external surface thereof with a coating which allows the sliding of the hollow solid propellant inside the wall(s) of the combustion chamber to be improved. The coating may, for example, be polytetrafluoroethylene.

The hollow solid propellant may further comprise one or more additives, such as polytetrafluoroethylene, in order to improve the chemical compatibility of the solid propellant with the fluid propellant or to improve the regression rate during combustion.

Furthermore, given the rigidity of the hollow solid propellant and in particular the grain of solid propellant, it also serves to transmit the thrust efforts from the nozzle to the payload of the propulsion system.

According to one embodiment, inside the hollow solid propellant and in particular the grain of solid propellant, there is an end-cap which is provided with a valve and, for example, an injector, which serves to delimit the portion of the hollow solid propellant, and in particular the grain of solid propellant, intended to contain the fluid propellant from the portion of the hollow solid propellant, and in particular the grain of solid propellant, intended to burn in the combustion chamber. The combustion chamber is the pressurized location where the combustion of the two propellants together takes place. The combustion is a chemical reaction of the two propellants which produces combustion gases at high temperatures which are discharged by a nozzle, in a direction counter to the direction of displacement desired by the payload of the propulsion system.

According to one aspect of the invention, the combustion chamber is closed by an end-cap and a valve and contains a hollow solid propellant, the internal face of which burns with a fluid propellant which is injected through the end-cap. The chamber may further be closed by the hollow solid propellant which is inserted in the combustion chamber.

The internal face of the hollow solid propellant is in particular the surface of the hollow solid propellant which is located in the combustion chamber downstream of the end-cap.

Furthermore, the nozzle is an opening of the combustion chamber which allows the hot gases produced during the combustion of the propellants to be discharged so as to propel the payload of the propulsion system.

The propulsion chamber may comprise a wall with a shape which complements the shape of the hollow solid propellant so that it is inserted in the combustion chamber and slides on the wall(s) of the chamber during the combustion thereof. The wall (s) of the combustion chamber thus form a container for receiving a first portion of the hollow solid propellant, a second portion of the hollow solid propellant which contains the fluid propellant extending out of the combustion chamber before both are inserted in the combustion chamber.

According to one embodiment, the combustion chamber is partially delimited by the first portion of hollow solid propellant and the end-cap.

Furthermore, the end-cap may hermetically close the cavity which is formed in the hollow solid propellant, the valve serving to circulate the fluid propellant of the cavity towards the combustion chamber.

The rocket motor may comprise one or more insertion systems for the propellants which allow(s) the hollow solid propellant to be inserted, and in particular the grain of solid propellant, in the combustion chamber and allow(s) the end-cap to be moved while the hollow solid propellant, and in particular the grain of solid propellant, which has a shape which may be cylindrical, burns.

The propulsion system according to the invention is an autophage system in the sense that it consumes its own structure. This is because the hollow solid propellant is gradually introduced inside the combustion chamber during the consumption of the hollow solid propellant.

When the hollow solid propellant is introduced into the combustion chamber, the storage volume of the fluid propellant decreases. This is because, with the insertion system(s) for the propellants generating a displacement of the hollow solid propellant in the combustion chamber during the combustion, the cavity which is closed by the end-cap and which stores the fluid propellant decreases. As a result of compression, particularly of the end-cap in the cavity which stores the fluid propellant, the fluid propellant is therefore also forced, via the valve, into the combustion chamber. A single insertion system for propellants may be sufficient to force the two propellants into the chamber.

According to a specific embodiment, the rocket motor further comprises a connection means for at least one wall of the combustion chamber to the end-cap in order to mechanically connect the end-cap to the combustion chamber.

The mechanical connection can keep the end-cap at a specific position relative to the combustion chamber while allowing a movement, for example, a rotational movement, of the end-cap. Alternatively, the end-cap may be kept in a fixed position by the connection means in the rocket motor.

The connection means may comprise at least one knife which mechanically connects the at least one wall of the combustion chamber to the end-cap. In this case, the mechanical connection is a knife in the sense that the first portion of the hollow solid propellant which is inserted in the combustion chamber is passed through at least partially by the at least one knife during insertion.

In particular, with the hollow solid propellant being subjected to a great internal pressure during its insertion into the combustion chamber, it can readily be passed through by the blades during the penetration of the grain of solid propellant into the combustion chamber. This is because the knifes cut the grain of solid propellant, particularly in the direction of insertion of the grain of solid propellant. The knife(s) which pass(es) through the hollow solid propellant also has/have the effect of preventing a rotational movement of the hollow solid propellant. In other words, the connection means further has an objective of stopping the hollow solid propellant in terms of rotation.

The knife(s) mechanically connect(s) the end-cap to the wall(s) of the combustion chamber, they cut the hollow solid propellant at the introduction rate of the hollow solid propellant into the combustion chamber.

When the end-cap is mechanically connected to the wall(s) of the combustion chamber by means of a plurality of knifes, they can have different lengths. This is because the blades can mechanically connect the end-cap to the wall(s) of the combustion chamber at different heights in the combustion chamber. According to another embodiment, the knifes can have the same length.

The rocket motor may further comprise an insertion system for the propellants which will control the insertion of the grain of solid propellant into the combustion chamber and the introduction of the fluid propellant into the combustion chamber.

The insertion system may comprise a means for generating a translational movement of the hollow solid propellant in order to insert it into the combustion chamber during the combustion. The insertion system for the propellants may be connected to the end-cap. According to another embodiment, the end-cap may comprise the insertion system for the propellants.

The means for generating a translational movement of the hollow solid propellant is suitable for generating a translational movement of the hollow solid propellant relative to the wall(s) of the combustion chamber and/or relative to the end-cap.

For example, it is possible (or not) to imagine that an insertion system for the propellants may be located in the region of the end-cap and that the end-cap may be mechanically connected to the chamber, thereby moving at the same rate inside the hollow solid propellant and in particular the grain of solid propellant. For example, the end-cap and the combustion chamber may be connected by a specific number of knifes. Where necessary, the hollow solid propellant and in particular the grain of solid propellant, which is already subjected to a powerful internal pressure, is readily cut by the knifes while it is being introduced into the chamber.

In particular, the means for generating a translational movement of the hollow solid propellant may, for example, be carried out by means of a leadscrew type system. The means for generating a translational movement of the hollow solid propellant may comprise a screw which is suitable for being rotated in a threading which forms a face of the hollow solid propellant so as to apply an effort in order to insert it in the combustion chamber. The threading which forms a face of the hollow solid propellant may particularly form the internal face of the hollow solid propellant.

For example, the hollow solid propellant may comprise a thread on the internal wall of the cavity in order to interface with a screw which is formed around the end-cap. The thread is obtained, for example, by tapping. The end-cap which closes the cavity may comprise a screw thread which complements the thread located on the internal wall of the cavity. According to another embodiment, the screw is connected to the end-cap but the rotation of the screw does not bring about a rotational movement of the end-cap.

A mechanical insertion system for the grain may be, for example, composed of a leadscrew system, in which the hollow solid propellant, in particular the grain of solid propellant, comprises an internal thread which interfaces with a screw around the end-cap.

According to a specific embodiment, the hollow solid propellant may be covered with a coating which allows a reduction in the friction of the screw when it interfaces with the screw thread which forms a face of the hollow solid propellant. The coating may be, for example, polytetrafluoroethylene.

The rocket motor may further comprise a mechanical rotation system such as an electric motor which is supplied by batteries, fuel cells, gas generator or any other source of electricity which allows the screw to turn, thereby moving the hollow solid propellant and in particular the grain of solid propellant, in terms of translation.

A turbine which uses the combustion gases, or any other system, may also be considered to drive the screw or the end-cap which is provided with a screw thread. Thus, the insertion system for the propellants allows the combustion chamber to be supplied with hollow solid propellant and the compression of the end-cap in the cavity which is brought about by the displacement of the hollow solid propellant allows the introduction of the fluid propellant into the combustion chamber via the valve.

In this specific embodiment based on the leadscrew system, the insertion system for the propellants controls the rotation of the screw, which will turn relative to the hollow solid propellant. This leadscrew system allows conversion of the rotational movement of the screw into a translational movement of the hollow solid propellant which displaces the hollow solid propellant in the combustion chamber. The hollow solid propellant also moves in terms of translation relative to the end-cap.

This translational movement of the hollow solid propellant involves a reduction in the size of the cavity since the end-cap is not subjected to such a translational movement in the combustion chamber. Thus, the pressure on the fluid propellant will increase in the cavity which is closed by the end-cap.

According to another embodiment, the leadscrew system is transposed between the hollow solid propellant and the end-cap. In other words, the hollow solid propellant may comprise the screw and the nut may be formed by the combustion chamber or the end-cap.

The rotational movement of the grain can be stopped in the leadscrew system with the knifes previously described or another system for stopping rotation, whatever it may be.

The system for rotating the screw could also be advantageous for driving a pump which would be used to increase the pressure of the fluid propellant between the tank and the combustion chamber.

This is because, in this case, the pump which is driven by the system for rotation allows an increase in the pressure of the fluid propellant which is contained in the cavity in view of its introduction into the combustion chamber.

The characteristics of the solid grain may be adapted using coatings, additives or a specific micro-structure. For example, a layer of polytetrafluoroethylene may further be applied to the hollow solid propellant, in particular to the grain of solid propellant, in order to allow it better chemical compatibility with the fluid propellant, a better sealing in the thread or a reduced friction with respect to the screw or the wall of the combustion chamber. The hollow solid propellant, in particular the grain of solid propellant, may also be composed of several materials: the external enclosure in the form of a covering of the hollow solid propellant, in particular the grain of solid propellant, can be constituted by a thermal ablative material which releases cold gases while being pyrolyzed, which would serve to insulate the walls of the combustion chamber and of the nozzle. It is also possible to consider using composite materials as hollow solid propellant, in particular the grain of solid propellant, or to carry it out using an additive manufacturing process.

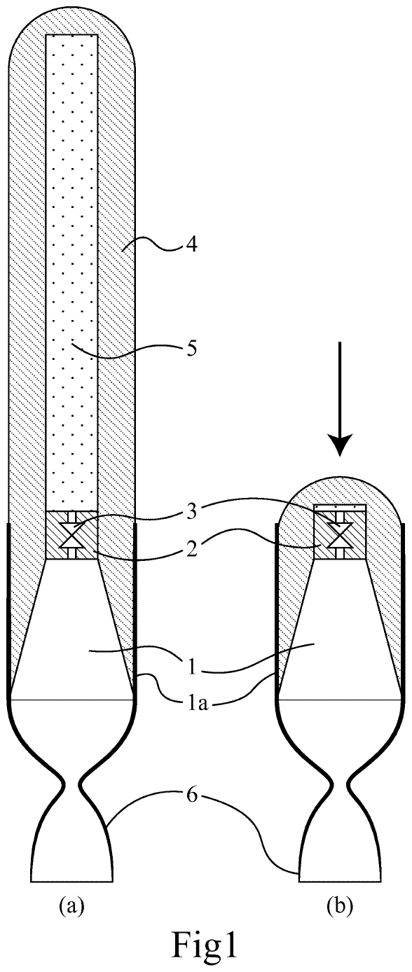

FIG. 1 illustrates an embodiment of the invention in the case of a hybrid rocket motor.

According to one embodiment, the propellants used by the hybrid rocket motor are a liquid cryogenic oxidant and a solid fuel at ambient temperature, respectively, but the invention can be carried out with other combinations of propellants. FIG. 1(a) illustrates a hybrid rocket motor which comprises a hollow solid propellant, in particular a grain of solid propellant, and a fluid propellant which has to be consumed in order to bring about the thrust necessary for the displacement of the payload of the propulsion system while FIG. 1(b) illustrates the hybrid rocket motor in which the majority of the hollow solid propellant, in particular the grain of solid propellant, and the fluid propellant has been consumed in order to illustrate the autophage aspect of the propulsion system.

The combustion chamber 1, which is capable of withstanding the pressure at the interior thereof, is closed by an end-cap 2 and a valve 3 which delimit two portions in the hollow solid propellant, in particular the grain of solid propellant 4: the zone which is intended for the combustion in the combustion chamber 1 and the zone which is intended for storing the fluid propellant 5.

The combustion chamber 1 is particularly delimited by a wall 1a which is connected to a nozzle 6 in order to eject the combustion gases and to allow the propulsion by thrust of the payload of the propulsion system.

The combustion chamber also comprises opposite the nozzle an opening which is suitable for receiving some of the hollow solid propellant, in particular the grain of solid propellant 4, which has a storage cavity for a fluid propellant 5. This opening is closed by the end-cap and the valve.

As illustrated, the plug and the valve also serve to close the cavity of the hollow solid propellant 4. The end-cap may comprise the valve.

The cavity comprises, for example, a constant and regular diameter, such as, for example, a tube, and the end-cap has a diameter corresponding to the diameter of the cavity.

In the embodiment illustrated, the external face of the hollow solid propellant 4 has a shape which complements the wall 1a of the combustion chamber 1 in order to be introduced into the chamber 1 during the consumption of the solid propellant and the fluid propellant.

The fluid propellant 5 can be introduced into the combustion chamber by means of the valve 3, for example, when a pressure is applied by the end-cap to the fluid propellant in the cavity of the hollow solid propellant.

As illustrated in FIG. 1, the portion of the hollow solid propellant located between the end-cap and the wall of the combustion chamber 1a is used for combustion. Furthermore, the portion of the solid propellant located above the combustion chamber acts as a container for the fluid propellant before both are introduced into the combustion chamber 1.

Thus, during use of the hollow solid propellant located in the combustion chamber and the fluid propellant, the two propellants located upstream of the combustion chamber are inserted into the combustion chamber in order to be consumed, thereby reducing the size of the propulsion system until the majority of the hollow solid propellant and the fluid propellant is consumed, as illustrated in FIG. 1(b). The combustion is carried out by burning the hollow solid propellant located in the combustion chamber and the fluid propellant 5 which is introduced into the combustion chamber.

By being introduced into the combustion chamber 1 and burning with the hollow solid propellant, in particular the grain of solid propellant 4, the fluid propellant 5 generates combustion gases which are subsequently ejected by the nozzle 6 which allows propulsion by reaction of the system. The combustion is a chemical reaction of the two propellants for producing gases which are used for thrust.

The portion of hollow solid propellant located in the combustion chamber 1 may comprise a decreasing thickness, as illustrated in FIG. 1. In other words, the surface of the propellant which is burnt, that is to say the internal face of the hollow solid propellant, may be approximately cone-shaped.

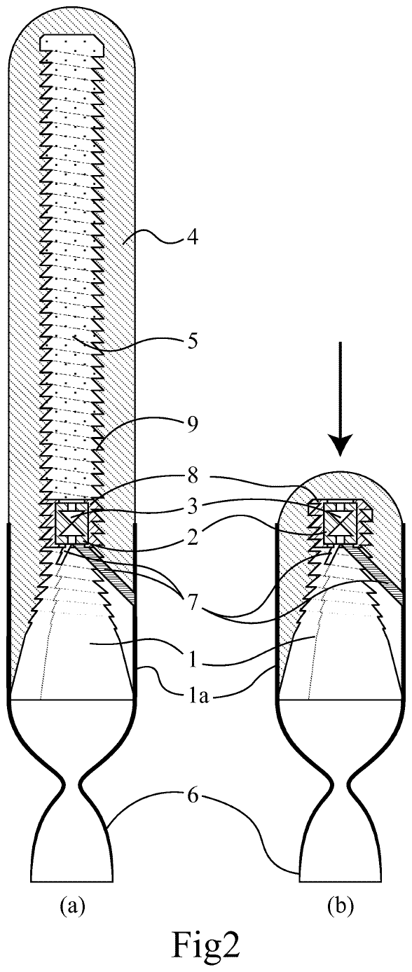

FIG. 2 illustrates an exemplary embodiment of the hybrid rocket motor of the invention, in which the hollow solid propellant is carried into the combustion chamber by means of an insertion system for the propellants. The insertion system for the propellants illustrated in FIG. 2 is based on a leadscrew type system. FIG. 2(a) illustrates the hybrid rocket motor which contains a hollow solid propellant and a fluid propellant which have to be consumed while FIG. 2(b) illustrates the hybrid rocket motor in which the majority of the hollow solid propellant, in particular the grain of solid propellant, and the fluid propellant has been consumed in order to illustrate the autophage aspect of the propulsion system.

As illustrated in FIG. 2(a), the internal face of the hollow solid propellant 4, that is to say the cavity, comprises a threading 9. According to a specific embodiment, the threading 9 is brought about over all or some of the surface of the cavity of the hollow solid propellant.

In the embodiment illustrated, the threading 9 present on the cavity of the hollow solid propellant will act as the nut.

According to the embodiment illustrated in FIG. 2, the end-cap2 comprises on the external surface thereof a screw 8 of the insertion system for the propellants which is suitable for being rotated in a threading 9 which forms the internal face of the hollow solid propellant 4, that is to say the cavity, so as to apply an effort in order to insert it into the combustion chamber. This leadscrew system allows conversion of the rotational movement of the screw into a translational movement of the hollow solid propellant, thereby displacing the hollow solid propellant in the combustion chamber.

Alternatively, the leadscrew system is transposed between the hollow solid propellant and the end-cap.

The end-cap may comprise the screw. However, the screw may be different from the end-cap. The rocket motor illustrated in FIG. 2 may comprise a connection means 7 for at least one wall of the combustion chamber 1 to the end-cap 2. The connection means illustrated is formed by knifes 7. The knifes may be of different sizes, in particular they may have different lengths.

According to an embodiment illustrated, the end-cap 2 is mechanically connected to the combustion chamber 1 by means of knifes 7 which take up the internal pressure efforts. The knifes 7 pass through the grain of solid propellant 4.

When the rocket motor is operational, the screw 8 turns, moving the internal threading 9 in translation in the hollow solid propellant, in particular the grain of solid propellant 4, and thereby moves the hollow solid propellant in translation towards the inner side of the combustion chamber 1.

According to a particular embodiment, the hollow solid propellant, in particular the grain of solid propellant 4, cannot turn relative to the combustion chamber because it is blocked in terms of rotation by the knifes 7 and it is therefore forced to move axially into the combustion chamber 1.

The fluid propellant 5 is contained in a volume which is decreasing because the end-cap 2 advances into the hollow solid propellant, in particular the grain of solid propellant 4. This is because the volume of the cavity of the hollow solid propellant 4 which contains the fluid propellant 5 decreases during combustion because the hollow solid propellant 4 carries out a translational movement relative to the end-cap 2.

This reduction in the volume forces the fluid propellant 5 through the valve 3 into the combustion chamber 1. The rotation speed of the screw 8 therefore produces the mass flow rate to be introduced into the combustion chamber.

Since the hollow solid propellant, in particular the grain of solid propellant, advances into the chamber while it burns, the internal surface of the hollow solid propellant, in particular the grain of solid propellant 4, present in the combustion chamber, will have a conical shape in the chamber 1 and the shape of this surface will be stationary during the combustion for a fixed rotation speed of the screw 8.

Since the regression rate is virtually constant along the chamber, the hollow solid propellant present in the combustion chamber consequently takes up an approximately conical shape.

### Industrial Application

This type of propulsion is particularly suitable for space launch vehicles. When the combustion reaches its end, the rocket motor will have consumed a majority of the hollow solid propellant, in particular the grain of solid propellant. The remaining mass of the space launch vehicle which uses this propulsion device will therefore be very small at the end of combustion.

### Declarations

Hybrid rocket motor in which a pressurized combustion chamber (1) which is closed by an end-cap (2) and a valve (3) contains a hollow solid propellant (4), the internal face of which burns with a fluid propellant (5) which is injected through the end-cap (2), generating hot gases (6) which are discharged via a nozzle (6) so as to produce a thrust on the vehicle, characterized in that a portion which is delimited by the end-cap (2) of the hollow solid propellant (4) acts as a container for the fluid propellant (5) before both are inserted into the combustion chamber (1).

Hybrid rocket motor in which a pressurized combustion chamber (1) which is closed by an end-cap (2) and a valve (3) contains a hollow solid propellant (4), the internal face of which burns with a fluid propellant (5) which is injected through the end-cap (2), generating hot gases (6) which are discharged via a nozzle (6) so as to produce a thrust on the vehicle, characterized in that a portion of the hollow solid propellant (4) travels beyond and around the end-cap (2) out of the combustion chamber (1) and contains the fluid propellant (5) before both are inserted into the combustion chamber (1).

Rocket motor according to the preceding declarations, characterized in that a specific number of knifes (7) connect the combustion chamber (1) to the end-cap (2), of which the exterior is a screw (8) which is rotated in a thread (9) which forms the internal face of the hollow solid propellant (4) so as to apply an effort in order to insert it into the chamber.

Rocket motor according to the preceding declaration, characterized in that the rotation of the screw (8) also drives a pump which allows additional pressurization of the fluid propellant (5) between the interior of the solid propellant (4) and the combustion chamber (1).

Rocket motor according to the preceding declarations, characterized in that the screw (8) is rotated by an electric motor supplied by an energy source, such as batteries, fuel cells, or a gas generator.

Rocket motor according to any one of the preceding declarations, characterized in that the screw (8) is rotated by a turbine which is driven by the gases produced by combustion.

Rocket motor according to any one of the preceding declarations, characterized in that a thermal ablative layer is located on the exterior of the solid propellant (4) and releases cold gases in order to insulate the walls of the chamber (1) and of the nozzle (6).

Rocket motor according to any one of the preceding declarations, characterized in that the solid propellant (4) is a composite material.

Rocket motor according to any one of the preceding declarations, characterized in that the solid propellant (4) is produced by additive manufacturing.

Rocket motor according to any one of the preceding declarations, characterized in that the hollow solid propellant comprises additives in order to allow the characteristics of density, mechanical strength, thermal conductivity, regression rate during combustion, radial distribution of temperature of the exhaust gases, chemical compatibility, mean molar mass of the exhaust gases, friction characteristic, or any other physical characteristic of the solid propellant (4) and the combustion products thereof with the fluid propellant (5) to be improved.

1. Hybrid rocket motor comprising a combustion chamber which is supplied by a hollow solid propellant (4) and a fluid propellant (5), the hollow solid propellant having a cavity which is closed by a plug and a valve, and the fluid propellant being stored in the cavity of the hollow solid propellant.

2. Rocket motor according to the preceding claim, characterized in that the hollow solid propellant comprises:
a first portion which is inserted in the combustion chamber in order to be burnt there with fluid propellant (5) which is injected into the combustion chamber through the valve, and
a second portion (4) which extends out of the combustion chamber (1) and which contains the fluid propellant (5) before both are inserted into the combustion chamber (1).

3. Rocket motor according to claim 1 or claim 2, characterized in that it further comprises a connection means which connects at least one wall of the combustion chamber (1) and the end-cap (2).

4. Rocket motor according to the preceding claim, characterized in that the connection means comprises at least one knife (7) which mechanically connects the at least one wall of the combustion chamber to the end-cap, and in that the first portion of the hollow solid propellant is passed through by the at least one knife during insertion of the hollow solid propellant into the combustion chamber.

5. Rocket motor according to claim 3 or claim 4, characterized in that the connection means comprises a plurality of knifes which mechanically connect the at least one wall of the combustion chamber to the end-cap at different heights in the combustion chamber.

6. Rocket motor according to any one of the preceding claims, characterized in that it further comprises an insertion system for the propellants in the combustion chamber.

7. Rocket motor according to the preceding claim, characterized in that the end-cap comprises the insertion System for the propellants.

8. Rocket motor according to either claim 6 or 7, characterized in that the insertion system for the propellants comprises a means for generating a translational movement of the hollow solid propellant in order to insert it into the combustion chamber.

9. Rocket motor according to the preceding claim, characterized in that the means for generating a translational movement of the hollow solid propellant comprises a screw (8) which is suitable for being rotated in a thread (9) which forms a face of the hollow solid propellant (4) so as to apply an effort in order to insert it in the combustion chamber.

10. Rocket motor according to the preceding claim, characterized in that the thread (9) which forms a face of the hollow solid propellant forms the internal face of the hollow solid propellant (4).

11. Rocket motor according to claim 9 or claim 10, characterized in that the end-cap comprises the screw.

12. Rocket motor according to any one of claims 9 to 11, characterized in that the rotation of the screw (8) further drives a pump which is suitable for increasing the pressure of the fluid propellant when it is introduced into the combustion chamber (1).

13. Rocket motor according to any one of claims 9 to 12, characterized in that the screw (8) is rotated by an electric motor which is supplied by an energy source, such as batteries, fuel cells, or a gas generator.

14. Rocket motor according to any one of claims 9 to 12, characterized in that the screw (8) is rotated by a turbine which is driven by the gases produced by combustion.

15. Rocket motor according to any one of the preceding claims, characterized in that the hollow solid propellant (4) comprises a thermal ablative external layer which is suitable for releasing cold gases during combustion in order to insulate the wall(s) of the combustion chamber (1) and of a nozzle (6).

16. Rocket motor according to any one of the preceding claims, characterized in that the solid propellant (4) is formed by a composite material.

17. Rocket motor according to any one of the preceding claims, characterized in that the solid propellant (4) comprises one or more additives.

18. Rocket motor according to any one of the preceding claims, characterized in that the solid propellant (4) is produced by additive manufacturing.

19. Hybrid rocket motor, in which a pressurized combustion chamber (1) which is closed by an end-cap (2) and a valve (3) contains a hollow solid propellant (4), the internal face of which burns with a fluid propellant (5) which is injected through the end-cap (2), generating hot gases (6) which are discharged via a nozzle (6) so as to produce a thrust on the vehicle, characterized in that a portion which is delimited by the end-cap (2) of the hollow solid propellant (4) acts as a container for the fluid propellant (5) before both are inserted into the combustion chamber (1).

20. Rocket motor according to the preceding claim, characterized in that a portion of the hollow solid propellant travels beyond and around the end-cap out of the combustion chamber.

21. Rocket motor according to either claim 19 or claim 20, characterized in that the hollow solid propellant comprises a cavity, the cavity containing the fluid propellant and being closed by the end-cap and the valve.

22. Rocket motor according to any one of claims 19 to 21, characterized in that the combustion chamber is further closed by the hollow solid propellant which is inserted in the combustion chamber.

23. Rocket motor according to any one of claims 19 to 22, characterized in that the hollow solid propellant comprises
a first portion which is inserted in the combustion chamber in order to be burnt there with fluid propellant (5) which is injected into the combustion chamber through the valve, and
a second portion which extends out of the combustion chamber (1) and which contains the fluid propellant (5).

24. Rocket motor according to any one of claims 19 to 23, characterized in that it further comprises a connection means which connects at least one wall of the combustion chamber (1) and the end-cap (2).

25. Rocket motor according to the preceding claim, characterized in that the connection means comprises at least one knife which mechanically connects the at least one wall of the combustion chamber to the end-cap, and in that the hollow solid propellant which is contained in the combustion chamber is passed through by the at least one knife during insertion of the hollow solid propellant into the combustion chamber.

26. Rocket motor according to claim 24 or claim 25, characterized in that the connection means comprises a plurality of knifes which mechanically connect the at least one wall of the combustion chamber to the end-cap at different heights in the combustion chamber.

27. Rocket motor according to any one of claims 19 to 26, characterized in that it further comprises an insertion system for the propellants in the combustion chamber.

28. Rocket motor according to the preceding claim, characterized in that the end-cap comprises the insertion system for the propellants.

29. Rocket motor according to either claim 27 or claim 28, characterized in that the insertion system for the propellants comprises a means for generating a translational movement of the hollow solid propellant in order to insert it into the combustion chamber.

30. Rocket motor according to the preceding claim, characterized in that the means for generating a translational movement of the hollow solid propellant comprises a screw (8) which is suitable for being rotated in a thread (9) which forms a face of the hollow solid propellant (4) so as to apply an effort in order to insert it in the combustion chamber.

31. Rocket motor according to the preceding claim, characterized in that the thread (9) which forms a face of the hollow solid propellant forms the internal face of the hollow solid propellant (4).

32. Rocket motor according to claim 30 or claim 31, characterized in that the end-cap comprises the screw.

33. Rocket motor according to claim 19, characterized in that a specific number of knifes (7) connect the combustion chamber (1) to the end-cap (2), of which the exterior is a screw (8) which is rotated in a thread (9) which forms the internal face of the hollow solid propellant (4) so as to apply an effort in order to insert it into the chamber.

34. Rocket motor according to any one of claims 30 to 33, characterized in that the rotation of the screw (8) also drives a pump which allows additional pressurization of the fluid propellant between the interior of the solid propellant (4) and the combustion chamber (1).

35. Rocket motor according to any one of claims 30 to 34, characterized in that the screw (8) is rotated by an electric motor which is supplied by an energy source, such as batteries, fuel cells, or a gas generator.

36. Rocket motor according to any one of claims 30 to 34, characterized in that the screw (8) is rotated by a turbine which is driven by the gases produced by combustion.

37. Rocket motor according to any one of claims 19 to 36, characterized in that a thermal ablative layer is located on the exterior of the solid propellant (4) and releases cold gases in order to insulate the walls of the combustion chamber (1) and of the nozzle (6).

38. Rocket motor according to any one of claims 19 to 37, characterized in that the solid propellant (4) is a composite material.

39. Rocket motor according to any one of claims 19 to 38, characterized in that the solid propellant (4) comprises one or more additives.

40. Rocket motor according to any one of claims 19 to 39, characterized in that the solid propellant (4) is produced by additive manufacturing.
